(19) United States
(12) Patent Application Publication
(10) Pub. No.: US 2015/0188766 A1
(43) Pub. Date: Jul. 2, 2015

(54) MULTI-TERMINAL POSITIONING METHOD, AND RELATED DEVICE AND SYSTEM

(71) Applicant: HUAWEI TECHNOLOGIES CO., LTD., Shenzhen (CN)

(72) Inventors: Xingguang Song, Beijing (CN); Shiguo Lian, Beijing (CN); Wei Hu, Beijing (CN)

(73) Assignee: HUAWEI TECHNOLOGIES CO., LTD., Shenzhen (CN)

(21) Appl. No.: 14/573,531

(22) Filed: Dec. 17, 2014

(30) Foreign Application Priority Data
Dec. 30, 2013 (CN) 201310746331.5

(51) Int. Cl. H04L 12/24; H04W 4/02; H04L 29/08

(52) U.S. Cl. CPC H04L 41/0813; H04L 67/141; H04W 4/02; H04L 67/104

(57) ABSTRACT

The present invention discloses a multi-terminal positioning method, and a related device and system. The method includes: establishing, by a primary terminal after receiving a collaboration request activation signal triggered by a user, connections to secondary terminals in a wireless connection manner; calculating and displaying, by the primary terminal according to received device configuration parameters of the secondary terminals and the number of secondary terminals, at least one arrangement shape of all terminals and at least one demarcated gesture that matches each arrangement shape, and recording one arrangement shape selected by the user and one demarcated gesture that matches the arrangement shape; receiving, by the primary terminal, sensor trigger information sent by at least one secondary terminal; and calculating, by the primary terminal according to the recorded arrangement shape and demarcated gesture, and the sensor trigger information, an arrangement sequence of all terminals and relative positions between the terminals.

### CROSS-REFERENCE TO RELATED APPLICATION

This application claims priority to Chinese Patent Application No. 201310746331.5, filed on Dec. 30, 2013, which is hereby incorporated by reference in its entirety.

### TECHNICAL FIELD

The present invention relates to the field of intelligent terminal technologies, and in particular, to a multi-terminal positioning method, and a related device and system.

### BACKGROUND

Currently, after intelligent terminals become popular, a new trend appears. That is, multiple intelligent terminals are paired to work collaboratively, for example, multiple intelligent terminals are used to collaboratively display a picture, or multiple intelligent terminals are used to create a surround sound effect. To enable collaborative operation between among multiple terminals, relative positions between the terminals must be firstly determined.

In the prior art, multi-terminal positioning is mainly using two terminals that simultaneously transmit an ultrasonic signal to each other; and calculating a distance from one terminal to the other terminal by using a received ultrasonic signal sent by the other terminal and a received ultrasonic signal sent by the terminal itself. However, the manner of multi-terminal positioning by transmitting ultrasound in the prior art can only be performed between two terminals, and only the distance between the two terminals is calculated, so the positioning efficiency is low.

### SUMMARY

In view of this, embodiments of the present invention mainly aim to provide a multi-terminal positioning method, and a related device and system, so as to resolve a problem of low efficiency of multi-terminal positioning in the prior art.

To resolve the foregoing problem, the present invention provides the following technical solutions:

According to a first aspect, the present invention provides a multi-terminal positioning method, where the method includes:

establishing, by a primary terminal after receiving a collaboration request activation signal triggered by a user, connections to secondary terminals in a wireless connection manner;

calculating and displaying, by the primary terminal according to received device configuration parameters of the secondary terminals and the number of secondary terminals, at least one arrangement shape of all terminals and at least one demarcated gesture that matches each arrangement shape, and recording one arrangement shape selected by the user and one demarcated gesture that matches the arrangement shape;

receiving, by the primary terminal, sensor trigger information sent by at least one secondary terminal; and

calculating, by the primary terminal according to the recorded arrangement shape and demarcated gesture, and the sensor trigger information, an arrangement sequence of all terminals and relative positions between the terminals.

In a first implementation manner of the first aspect, the primary terminal is a terminal among all terminals that meets a preset condition.

With reference to the first aspect or the first implementation manner of the first aspect, in a second implementation manner of the first aspect, the sensor trigger information includes:

trigger time, a trigger manner, and a sensor triggering type; where

information about the sensor triggering type includes one or a combination of infrared triggering, light triggering and image triggering.

With reference to the first aspect, the first implementation manner of the first aspect, or the second implementation manner of the first aspect, in a third implementation manner of the first aspect, the calculating, by the primary terminal according to the recorded arrangement shape and demarcated gesture, and the sensor trigger information, an arrangement sequence of all terminals and relative positions between the terminals includes:

determining, by the primary terminal from at least one piece of sensor trigger information sent by each secondary terminal, sensor trigger information provided by a sensor of a highest priority;

arranging, by the primary terminal, the terminals in a sequence according to trigger time included in the sensor trigger information provided by the sensor of the highest priority in each terminal, and determining the arrangement sequence of the terminals according to the recorded arrangement shape and demarcated gesture; and

calculating, by the primary terminal according to the trigger time included in the sensor trigger information provided by the sensor of the highest priority in each terminal, a trigger time difference between successively triggered terminals as a relative position between the successively triggered terminals.

With reference to the third implementation manner of the first aspect, in a fourth implementation manner of the first aspect, the method further includes:

calculating, by the primary terminal according to the trigger time difference and an empirical speed value, a relative distance between the successively triggered terminals as the relative position between the successively triggered terminals.

In a fifth implementation manner of the first aspect, after the receiving, by the primary terminal, sensor trigger information detected by at least one secondary terminal, the method further includes:

determining, by the primary terminal, whether sensor trigger information sent by all the secondary terminals is received; if yes, calculating, according to the recorded arrangement shape and demarcated gesture, and the sensor trigger information, the arrangement sequence of all terminals and the relative positions between the terminals; and if no, displaying failure information and receiving again sensor trigger information sent by at least one secondary terminal.

With reference to the fifth implementation manner of the first aspect, in a sixth implementation manner of the first aspect, after the primary terminal determines that the sensor trigger information sent by all the secondary terminals is received, and before the calculating, according to the recorded arrangement shape and demarcated gesture, and the sensor trigger information, the arrangement sequence of all terminals and the relative positions between the terminals, the method further includes:

determining, by the primary terminal, whether an exception exists in the sensor trigger information; if yes, displaying failure information and receiving again sensor trigger information sent by at least one secondary terminal; and if no, calculating, according to the recorded arrangement shape and demarcated gesture, and the sensor trigger information, the arrangement sequence of all terminals and the relative positions between the terminals.

With reference to the sixth implementation manner of the first aspect, in a seventh implementation manner of the first aspect, the determining, by the primary terminal, whether an exception exists in the sensor trigger information includes:

determining, by the primary terminal according to the recorded arrangement shape and demarcated gesture, whether any abnormal trigger time exists in the sensor trigger information; or

determining, by the primary terminal, whether any abnormal sensor triggering type exists in the sensor trigger information.

According to a second aspect, the present invention provides a multi-terminal positioning method, where the method includes:

establishing, by a secondary terminal after receiving a collaboration request activation signal triggered by a user, a connection to a primary terminal in a wireless connection manner;

sending, by the secondary terminal, a device configuration parameter to the primary terminal, so that the primary terminal calculates and displays, according to received device configuration parameters of secondary terminals and the number of secondary terminals, at least one arrangement shape of all terminals and at least one demarcated gesture that matches each arrangement shape; and

when it is detected that a sensor is triggered, sending, by the secondary terminal, detected sensor trigger information to the primary terminal, so that the primary terminal calculates, according to the recorded arrangement shape and demarcated gesture, and the sensor trigger information, an arrangement sequence of all terminals and relative positions between the terminals.

In a first implementation manner of the second aspect, the primary terminal is a terminal among all terminals that meets a preset condition.

With reference to the second aspect or the first implementation manner of the second aspect, in a second implementation manner of the second aspect, the sensor trigger information includes:

trigger time, a trigger manner, and a sensor triggering type; where

information about the sensor triggering type includes one or a combination of infrared triggering, light triggering and image triggering.

According to a third aspect, the present invention provides a primary terminal, where the primary terminal includes:

a first receiving unit, configured to receive a collaboration request activation signal triggered by a user;

a connecting unit, configured to establish connections to secondary terminals in a wireless connection manner when the first receiving unit receives the collaboration request activation signal;

a second receiving unit, configured to receive device configuration parameters of the secondary terminals that have established connections to the primary terminal by using the connecting unit;

a first calculating unit, configured to calculate and display, according to the device configuration parameters received by the second receiving unit and the number of secondary terminals, at least one arrangement shape of all terminals and at least one demarcated gesture that matches each arrangement shape;

a recording unit, configured to, after the first calculating unit calculates and displays the at least one arrangement shape of all terminals and the at least one demarcated gesture that matches each arrangement shape, record one arrangement shape selected by the user and one demarcated gesture that matches the arrangement shape;

a third receiving unit, configured to receive sensor trigger information sent by at least one secondary terminal that has established a connection to the primary terminal by using the connecting unit; and

a second calculating unit, configured to calculate, according to the arrangement shape and the demarcated gesture that are recorded by the recording unit and the sensor trigger information received by the third receiving unit, an arrangement sequence of all terminals and relative positions between the terminals.

In a first implementation manner of the third aspect, the primary terminal is a terminal among all terminals that meets a preset condition.

With reference to the third aspect or the first implementation manner of the third aspect, in a second implementation manner of the third aspect, the sensor trigger information includes:

trigger time, a trigger manner, and a sensor triggering type; where

information about the sensor triggering type includes one or a combination of infrared triggering, light triggering and image triggering.

With reference to the third aspect, the first implementation manner of the third aspect, or the second implementation manner of the third aspect, in a third implementation manner of the third aspect, the second calculating unit includes:

an information determining subunit, configured to determine, from at least one piece of sensor trigger information that is sent by each secondary terminal and received by the third receiving unit, sensor trigger information provided by a sensor of a highest priority;

a sequence determining subunit, configured to arrange the terminals in a sequence according to trigger time included in the sensor trigger information that is provided by the sensor of the highest priority in each terminal and determined by the information determining subunit, and determine the arrangement sequence of the terminals according to the arrangement shape and the demarcated gesture that are recorded by the recording unit; and

a first position determining subunit, configured to calculate, according to the trigger time included in the sensor trigger information that is provided by the sensor of the highest priority in each terminal and determined by the information determining subunit, a trigger time difference between successively triggered terminals as a relative position between the successively triggered terminals.

With reference to the third implementation manner of the third aspect, in a fourth implementation manner of the third aspect, the second calculating unit further includes:

a second position determining subunit, configured to calculate, according to an empirical speed value and the trigger time difference that is obtained by the first position determining subunit by means of calculation, a relative distance between the successively triggered terminals as the relative position between the successively triggered terminals.

In a fifth implementation manner of the third aspect, the primary terminal further includes:

a failure prompting unit, configured to display failure information; and

a first validity determining unit, configured to determine whether the third receiving unit has received sensor trigger information detected by all the secondary terminals, where if a result of the determining of the first validity determining unit is yes, the second calculating unit calculates, according to the arrangement shape and the demarcated gesture that are recorded by the recording unit and the sensor trigger information received by the third receiving unit, the arrangement sequence of all terminals and the relative positions between the terminals; and if the result of the determining of the first validity determining unit is no, the failure prompting unit displays the failure information and the third receiving unit receives again sensor trigger information sent by at least one secondary terminal that has established a connection to the primary terminal by using the connecting unit.

In a sixth implementation manner of the third aspect, the primary terminal further includes:

a failure prompting unit, configured to display failure information; and

a second validity determining unit, configured to determine whether an exception exists in the sensor trigger information received by the third receiving unit, where, if a result of the determining of the second validity determining unit is yes, the failure prompting unit displays the failure information, and the third receiving unit receives again the sensor trigger information sent by at least one secondary terminal that has established a connection to the primary terminal by using the connecting unit; and if the result of the determining of the second validity determining unit is no, the second calculating unit calculates, according to the arrangement shape and the demarcated gesture that are recorded by the recording unit and the sensor trigger information received by the third receiving unit, the arrangement sequence of all terminals and the relative positions between the terminals.

With reference to the sixth implementation manner of the third aspect, in a seventh implementation manner of the third aspect, the second validity determining unit is specifically configured to:

determine, according to the arrangement shape and the demarcated gesture that are recorded by the recording unit, whether any abnormal trigger time exists in the sensor trigger information received by the third receiving unit; or

determine whether any abnormal sensor triggering type exists in the sensor trigger information received by the third receiving unit.

According to a fourth aspect, the present invention provides a secondary terminal, where the secondary terminal includes:

a receiving unit, configured to receive a collaboration request activation signal triggered by a user;

a connecting unit, configured to establish a connection to a primary terminal in a wireless connection manner when the receiving unit receives the collaboration request activation signal;

a first sending unit, configured to send a device configuration parameter to the primary terminal, so that the primary terminal calculates and displays, according to received device configuration parameter of secondary terminals and the number of secondary terminals, at least one arrangement shape of all terminals and at least one demarcated gesture that matches each arrangement shape; and

a second sending unit, configured to, when it is detected that a sensor is triggered, send detected sensor trigger information to the primary terminal, so that the primary terminal calculates, according to the recorded arrangement shape and demarcated gesture, and the sensor trigger information, an arrangement sequence of all terminals and relative positions between the terminals.

In a first implementation manner of the fourth aspect, the primary terminal is a terminal among all terminals that meets a preset condition.

With reference to the fourth aspect or the first implementation manner of the fourth aspect, in a second implementation manner of the fourth aspect, the sensor trigger information includes:

trigger time, a trigger manner, and a sensor triggering type; where

information about the sensor triggering type includes one or a combination of infrared triggering, light triggering and image triggering.

According to a fifth aspect, a multi-terminal positioning system is provided, where the system includes:

a primary terminal and several secondary terminals, where

the primary terminal is the primary terminal provided in the third aspect of the present invention; and

the secondary terminal is the secondary terminal provided in the fourth aspect of the present invention.

It can be seen that, the embodiments of the present invention have the following beneficial effects:

According to the embodiments of the present invention, a primary terminal informs a user of a possible arrangement shape of all terminals and a matching demarcated gesture. When the user triggers sensors of the terminals by using the demarcated gesture, the primary terminal may receive sensor trigger information detected by the terminals, and directly calculate an arrangement sequence of all terminals and relative positions of the terminals according to the sensor trigger information, a terminal arrangement shape selected by the user, and a corresponding demarcated gesture, so as to complete positioning of multiple terminals in only one demarcation process, thereby improving the positioning efficiency. In addition, according to the embodiments of the present invention, the sensor trigger information is obtained by using a gesture to trigger the sensors, which, with a strong anti-interference capability, is not easily subjected to interference from environmental noise.

### BRIEF DESCRIPTION OF DRAWINGS

FIG. 1 is a flowchart of Embodiment 1 of a multi-terminal positioning method in embodiments of the present invention;

FIG. 2(a) is a schematic diagram of a terminal arrangement shape according to an embodiment of the present invention;

FIG. 2(b) is a schematic diagram of a terminal arrangement shape and a matching demarcated gesture according to an embodiment of the present invention;

FIG. 3 is a schematic diagram of a trigger manner according to an embodiment of the present invention;

FIG. 4 is a flowchart of Embodiment 2 of the multi-terminal positioning method in the embodiments of the present invention;

FIG. 5 is a flowchart of Embodiment 3 of the multi-terminal positioning method in the embodiments of the present invention;

FIG. 6 is a schematic diagram of a terminal arrangement sequence according to an embodiment of the present invention;

FIG. 7 is a schematic diagram of relative positions of terminals according to an embodiment of the present invention;

FIG. 8 is a flowchart of Embodiment 4 of the multi-terminal positioning method in the embodiments of the present invention;

FIG. 9 is a flowchart of an embodiment of a multi-terminal positioning system in the embodiments of the present invention;

FIG. 10 is a schematic diagram of Embodiment 1 of a primary terminal in the embodiments of the present invention;

FIG. 11 is a schematic diagram of Embodiment 2 of the primary terminal in the embodiments of the present invention;

FIG. 12 is a schematic diagram of Embodiment 3 of the primary terminal in the embodiments of the present invention;

FIG. 13 is a schematic diagram of Embodiment 4 of the primary terminal in the embodiments of the present invention;

FIG. 14 is a schematic diagram of Embodiment 1 of a secondary terminal in the embodiments of the present invention; and

FIG. 15 is a schematic diagram of Embodiment 2 of the secondary terminal in the embodiments of the present invention.

### DESCRIPTION OF EMBODIMENTS

To make a person skilled in the art understand the technical solutions in the present invention better, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

A multi-terminal positioning method and a related device and system provided in the embodiments of the present invention can be applied to a multi-terminal collaboration scenario, where multi-terminal collaboration means that multiple terminal devices may be paired to perform various operations, and only after an arrangement sequence and relative positions between the terminals are determined can the terminals be used to perform collaborative operations, such as collaborative display and gesture recognition. However, problems of low efficiency and inaccurate measurement in multi-terminal positioning exist in the prior art. Therefore, the following multi-terminal positioning method and related device and system are provided in the embodiments of the present invention.

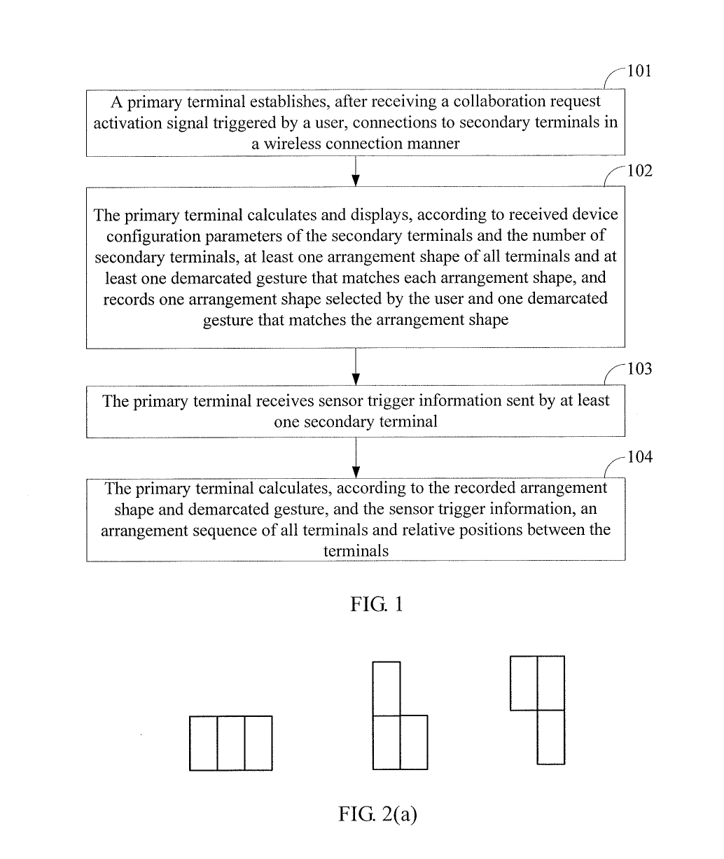

As shown in FIG. 1, Embodiment 1 of a multi-terminal positioning method in the embodiments of the present invention may include the following steps, and a primary terminal is used as an execution body in the description of this embodiment:

Step 101: The primary terminal establishes, after receiving a collaboration request activation signal triggered by a user, connections to secondary terminals in a wireless connection manner.

A collaboration function needs to be activated for all terminals that need to participate in collaboration. For example, a user may trigger the collaboration request activation signal by starting a dedicated application app (app is short for application). The primary terminal establishes, after receiving the collaboration request activation signal triggered by the user, connections to the secondary terminals in a wireless connection manner, where the wireless connection manner may be various manners, including but not limited to Miracast, 3G (3rd-generation, the third generation of mobile telecommunications technologies), Bluetooth, and so on. Wi-fi is wireless compatibility certification and is a technology that enables a personal computer, a handheld device, and other terminals to interconnect with each other in a wireless manner. Miracast is a certification program established by the Wi-Fi Alliance, and a wireless standard based on Wi-fi Direct (Wi-fi Direct).

In this embodiment, a terminal among all terminals that meets a preset condition may be determined as the primary terminal, and other terminals are determined as the secondary terminals. That is, the primary terminal is a terminal among all terminals that meets a preset condition. For example, a terminal that first starts an app may be determined as the primary terminal, or a terminal whose processor has a highest dominant frequency may be determined as the primary terminal. As a primary device in interaction, the primary terminal can receive user operation information and information sent by the secondary terminals, and implement multi-terminals positioning. The secondary terminals can send information such as a device configuration parameter or detected sensor trigger information to the primary terminal so that the primary terminal can implement multi-terminals positioning.

Step 102: The primary terminal calculates and displays, according to received device configuration parameters of the secondary terminals and the number of secondary terminals, at least one arrangement shape of all terminals and at least one demarcated gesture that matches each arrangement shape, and records one arrangement shape selected by the user and one demarcated gesture that matches the arrangement shape.

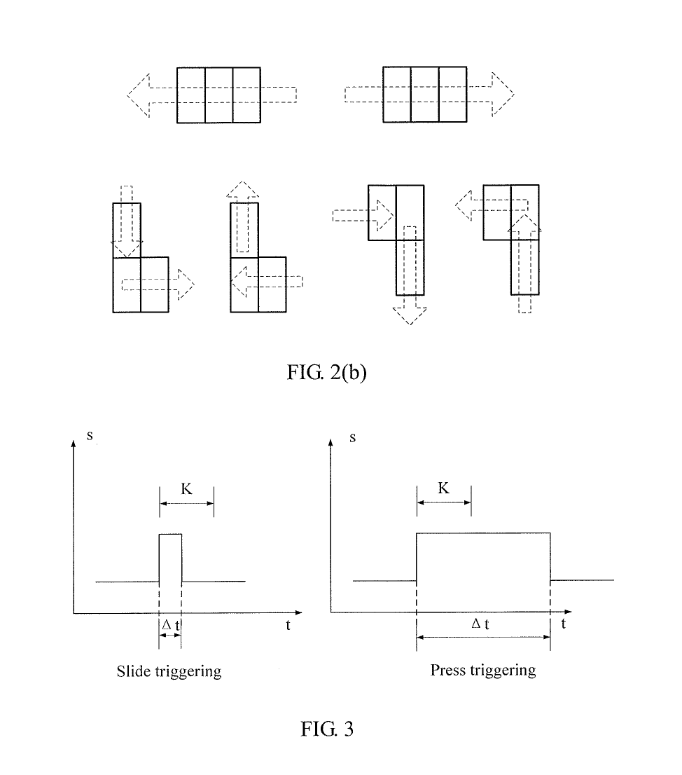

The secondary terminals may send device configuration parameters, for example, as a terminal screen size parameter and a screen resolution, to the primary terminal. The primary terminal may calculate, according to the device configuration parameters of the secondary terminals and the number of secondary terminals, a possible arrangement shape of all terminals. For example, as shown in FIG. 2(a), where three terminals are as an example, an arrangement shape of the terminals may be a line, an L shape, an inverted L shape, or the like. Each arrangement shape may match multiple demarcated gestures, for example, a clockwise, counterclockwise, or ZigZag gesture. As shown in FIG. 2(b), where three terminals are still as an example, a line-shaped arrangement shape may have two demarcated gestures: slide to the left and slide to the right; the arrangement shape of an L shape or inverted L shape may have a clockwise or counterclockwise demarcated gesture.

After calculating the at least one arrangement shape of all terminals and the at least one demarcated gesture that matches each arrangement shape, the primary terminal may display the arrangement shape and the demarcated gesture in a visible manner for the user to select. When the number of terminals is relatively small, all combinations of arrangement shapes and demarcated gestures may be displayed; and when the number of terminals is relatively large, a preferable combination of arrangement shapes and demarcated gestures may be displayed.

After the user selects the arrangement shape and the demarcated gesture, the primary terminal needs to record one arrangement shape selected by the user and one demarcated gesture that matches the arrangement shape.

Step 103: The primary terminal receives sensor trigger information sent by at least one secondary terminal.

Various sensors are disposed in a terminal. A sensor is triggered when the user slides on the terminal by using a demarcated gesture. The sensor may include but is not limited to an infrared sensor, a light sensor, a terminal capacitive screen, an ultrasonic detector, or an image sensor. Therefore, the demarcated gesture used by the user may be an air gesture.

Currently, sensors integrated to terminals are essentially switch-type sensors, and some sensors are further capable of detecting several discrete states. Therefore, a trigger manner may be classified into slide triggering or press triggering. As shown in FIG. 3, the trigger manner is mainly determined according to a change time Δt of a sensor state S: If Δt is greater than a time constant K, it may be considered as press triggering; and if Δt is less than the time constant K, it is slide triggering. The time constant K may be determined according to an empirical value and usually ranges from 1 s to 3 s.

The primary terminal and the secondary terminals can detect a change of sensor signals, and terminals (including the primary terminal and the secondary terminals) send detected sensor trigger information to the primary terminal. It should be noted that various sensors may be triggered in a gesture demarcation process, and in this case, various sensor trigger information is sent to the primary terminal altogether. In some embodiments of the present invention, the sensor trigger information may include but is not limited to trigger time, a trigger manner, and a sensor triggering type. The sensor triggering type may include but is not limited to one or a combination of infrared triggering, light triggering and image triggering. If the trigger manner is press triggering, the trigger time may be a boundary time when the triggering starts or ends.

Step 104: The primary terminal calculates, according to the recorded arrangement shape and demarcated gesture, and the sensor trigger information, an arrangement sequence of all terminals and relative positions between the terminals.

On a precondition that the arrangement shape and the demarcated gesture are determined, the primary terminal may calculate the arrangement sequence of all terminals and the relative positions between the terminals according to the sensor trigger information detected by the terminals. The arrangement sequence indicates horizontal, vertical and like arrangement sequences of the terminals, and a relative position indicates a specific position relationship, for example a distance, between terminals.

In this embodiment, a primary terminal informs a user of a possible arrangement shape of all terminals and a matching demarcated gesture. When the user triggers sensors of the terminals by using the demarcated gesture, the primary terminal may receive sensor trigger information detected by the terminals, and directly calculate an arrangement sequence of all terminals and relative positions between the terminals according to the sensor trigger information, a terminal arrangement shape selected by the user, and a corresponding demarcated gesture, so as to complete positioning of multiple terminals in only one demarcation process, thereby improving the positioning efficiency. In addition, according to this embodiment of the present invention, the sensor trigger information is obtained by using a gesture to trigger the sensors, which, with a strong anti-interference capability, is not easily subjected to interference from environmental noise.

In some embodiments of the present invention, in the multi-terminal positioning method according to this embodiment of the present invention, after the primary terminal receives sensor trigger information detected by the terminals, validity of the sensor trigger information may be determined in advance to improve accuracy of subsequent calculation of the arrangement sequence of all terminals and the relative positions of the terminals.

Specifically, in some embodiments of the present invention, after the primary terminal receives the sensor trigger information detected by the at least one secondary terminal, the multi-terminal positioning method further includes:

determining, by the primary terminal, whether sensor trigger information sent by all the secondary terminals is received; if yes, calculating, according to the recorded arrangement shape and demarcated gesture, and the sensor trigger information, the arrangement sequence of all terminals and the relative positions between the terminals; and if no, displaying failure information and receiving again sensor trigger information sent by at least one secondary terminal.

In some embodiments of the present invention, after the primary terminal determines that the sensor trigger information sent by all the secondary terminals is received, and before the calculating, according to the recorded arrangement shape and demarcated gesture, and the sensor trigger information, the arrangement sequence of all terminals and the relative positions between the terminals, the multi-terminal positioning method further includes:

determining, by the primary terminal, whether an exception exists in the sensor trigger information; if yes, displaying failure information and receiving again sensor trigger information sent by at least one secondary terminal; and if no, calculating, according to the recorded arrangement shape and demarcated gesture, and the sensor trigger information, the arrangement sequence of all terminals and the relative positions between the terminals.

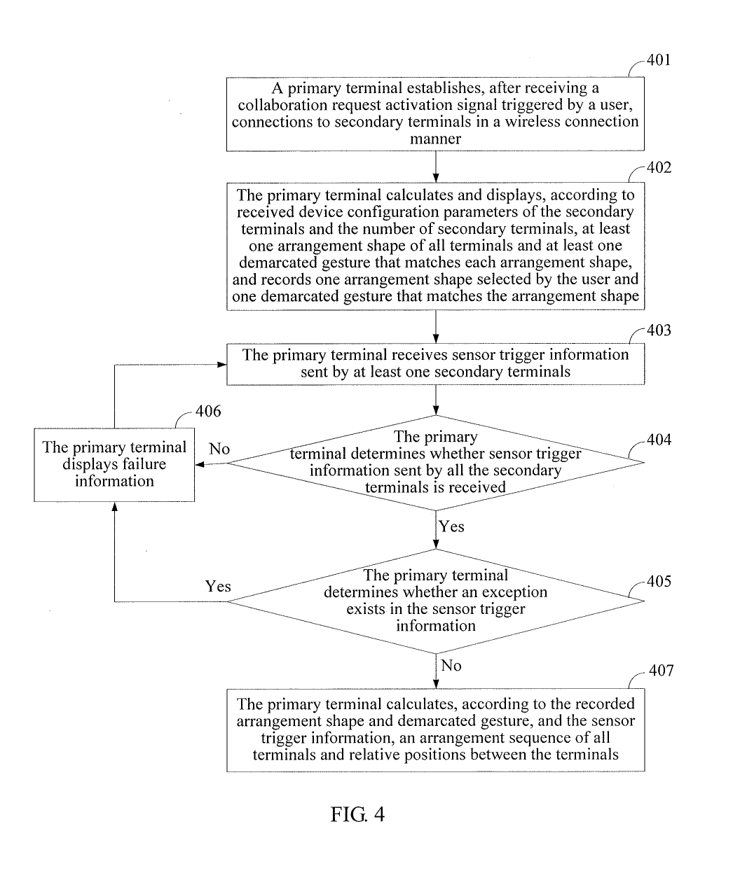

Therefore, as shown in FIG. 4, Embodiment 2 of the multi-terminal positioning method in the embodiments of the present invention may include the following steps:

Step 401: A primary terminal establishes, after receiving a collaboration request activation signal triggered by a user, connections to secondary terminals in a wireless connection manner.

Step 402: The primary terminal calculates and displays, according to received device configuration parameters of the secondary terminals and the number of secondary terminals, at least one arrangement shape of all terminals and at least one demarcated gesture that matches each arrangement shape, and records one arrangement shape selected by the user and one demarcated gesture that matches the arrangement shape.

Step 403: The primary terminal receives sensor trigger information sent by at least one secondary terminal.

Step 404: The primary terminal determines whether sensor trigger information sent by all the secondary terminals is received; if yes, goes to step 405; and if no, goes to step 406.

The primary terminal receives the sensor trigger information of the terminals, and the information includes, if the primary terminal is a terminal that also needs to be positioned, sensor trigger information of the primary terminal and sensor trigger information of the secondary terminals. The primary terminal determines whether the sensor trigger information of all terminals is received, so as to preliminarily determine validity of the information, and if yes, preliminarily determines that the information is valid and that further validity determination is needed; otherwise, the primary terminal displays failure information in a visible or another manner to inform the user that gesture demarcation is unsuccessful and a new demarcation is required.

Step 405: The primary terminal determines whether an exception exists in the sensor trigger information; if yes, goes to step 406; and if no, goes to step 407.

After receiving the sensor trigger information of all terminals, the primary terminal needs to determine the validity of and filter the trigger information. The purpose of validity determination is to remove false trigger information caused by a system delay or a detection error, so as to improve system calculation accuracy, where common false trigger information includes abnormal trigger time, an abnormal sensor triggering type, or the like. After determining the validity of the trigger information, an arrangement sequence and relative positions of the terminals may be obtained by means of calculation according to a combination of a terminal arrangement shape parameter and demarcated gesture information.

Specifically, in some embodiments of the present invention, a specific implementation manner in which the primary terminal determines whether an exception exists in the sensor trigger information may include:

determining, by the primary terminal according to the recorded arrangement shape and demarcated gesture, whether any abnormal trigger time exists in the sensor trigger information;

or determining, by the primary terminal, whether any abnormal sensor triggering type exists in the sensor trigger information.

Step 406: The primary terminal displays failure information, and returns to step 403.

Step 407: The primary terminal calculates, according to the recorded arrangement shape and demarcated gesture, and the sensor trigger information, an arrangement sequence of all terminals and relative positions between the terminals.

In this embodiment, a primary terminal determines whether sensor trigger information detected by all terminals is received, determines whether an exception exists in the sensor trigger information, determines validity of the sensor trigger information, and notifies a user in time to perform multi-terminal positioning again when a gesture demarcation fails, thereby improving the positioning efficiency, avoiding inaccurate multi-terminal positioning caused by an abnormal sensor or other reasons, improving the calculation accuracy, and optimizing the implementation of multi-terminal positioning.

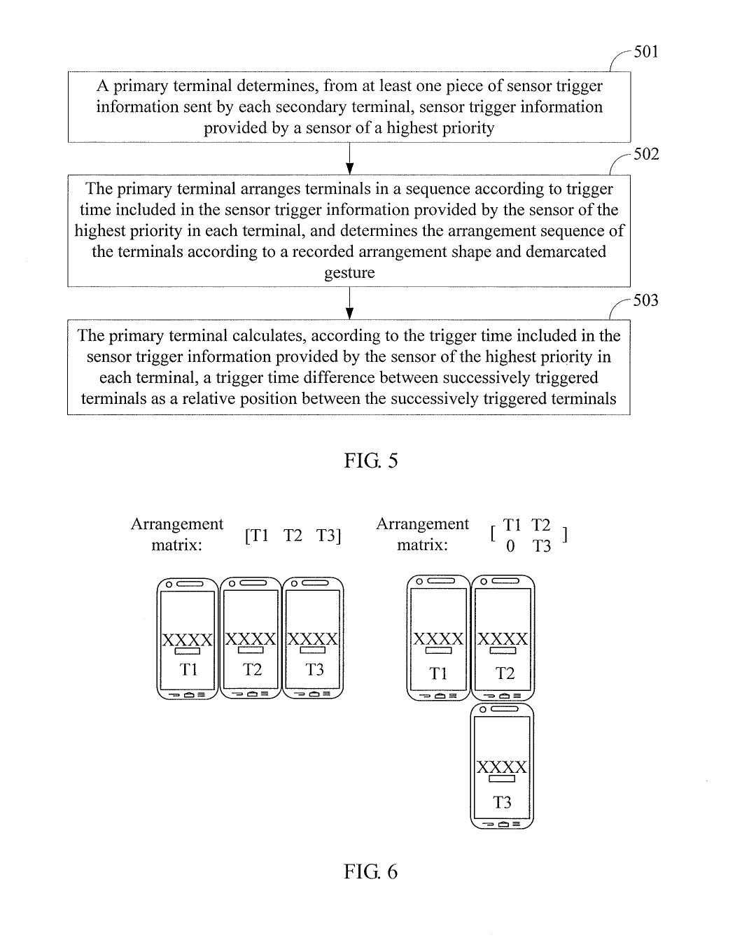

As shown in FIG. 5, Embodiment 3 of the multi-terminal positioning method in the embodiments of the present invention may include the following steps. In this embodiment, a specific implementation manner in which a primary terminal calculates an arrangement sequence of all terminals and relative positions between the terminals according to a recorded arrangement shape and demarcated gesture, and sensor trigger information is mainly described.

Step 501: The primary terminal determines, from at least one piece of sensor trigger information sent by each secondary terminal, sensor trigger information provided by a sensor of a highest priority.

In this embodiment, the primary terminal filters the received sensor trigger information and each terminal saves one piece of most significant sensor trigger information. For example, a sensor priority may be set, and infrared trigger information in multiple pieces of sensor trigger information of a terminal is determined as sensor trigger information provided by a sensor of a highest priority. When the infrared trigger information of the terminal is abnormal, light trigger information may be used as the sensor trigger information provided by a sensor of a highest priority.

Step 502: The primary terminal arranges the terminals in a sequence according to trigger time included in the sensor trigger information provided by the sensor of the highest priority in each terminal, and determines the arrangement sequence of the terminals according to the recorded arrangement shape and demarcated gesture.

The primary terminal arranges the sensor trigger information of the terminals according to a time sequence, and the arrangement shape of the terminals and a direction of the demarcated gesture are known; and therefore, the arrangement sequence of the terminals may be obtained. The arrangement sequence may be described by using an arrangement matrix; however, a manner in which the arrangement sequence of the terminals is described is not limited to use of an arrangement matrix.

As shown in FIG. 6, three terminals are used as an example. When the three terminals (T1, T2, and T3) are sequentially arranged in a line, the arrangement sequence of the terminals may be described by an arrangement matrix [T1 T2 T3]. When the three terminals (T1, T2, and T3) are sequentially arranged in an inverted L shape, the arrangement sequence of the terminals may be described by an arrangement matrix

$$[ \begin{matrix}T 1 & T 2 \\ 0 & T 3\end{matrix} ] .$$

Step 503: The primary terminal calculates, according to the trigger time included in the sensor trigger information provided by the sensor of the highest priority in each terminal, a trigger time difference between successively triggered terminals as a relative position between the successively triggered terminals.

A relative position between terminals may refer to a distance between the terminals. In this embodiment, because the terminals are triggered by sensors, this distance mainly refers to a distance between sensors. The distance may be measured in many manners, for example, a physical distance, or according to a time difference between triggered sensors in a gesture sliding process (herein it is assumed that a person's gesture sliding speed is basically constant in one scenario). In this embodiment, a time difference Δt may be used to describe a relative position between terminals.

The primary terminal calculates a trigger time difference between sensor trigger information of successively triggered sensors and obtains a relative position between the terminals. The relative position may be described by using a position matrix; however, a manner in which relative positions between terminals are described is not limited to the position matrix.

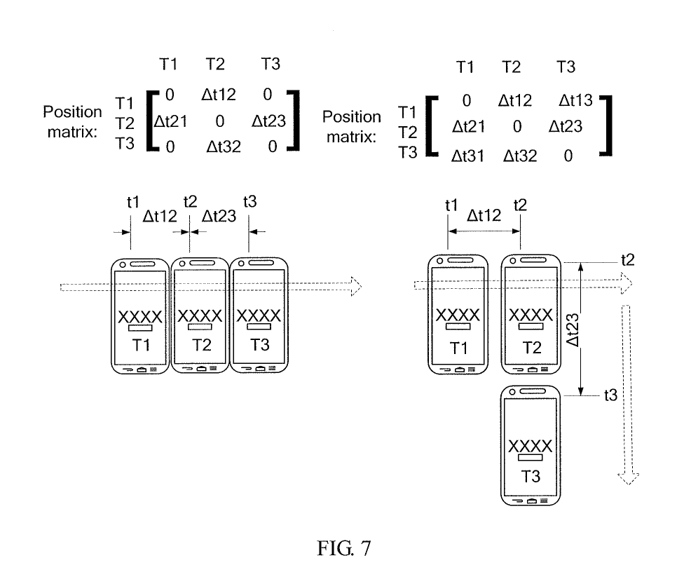

As shown in FIG. 7, three terminals are still used as an example. When the three terminals (T1, T2, and T3) are sequentially arranged in a line, a trigger time difference between T1 and T2 is Δt12 a trigger time difference between T2 and T3 is Δt23 and relative positions between the terminals may be described by a position matrix

$$\begin{matrix}\begin{matrix}\begin{matrix} \\ T 1\end{matrix} \\ T 2\end{matrix} \\ T 3\end{matrix} \begin{matrix}\begin{matrix}T 1 & T 2 & T 3\end{matrix} \\ [ \begin{matrix}0 & Δ t 12 & 0 \\ Δ t 21 & 0 & Δ t 23 \\ 0 & Δ t 32 & 0\end{matrix} ]\end{matrix} .$$

When the three terminals are sequentially arranged in an inverted L shape, a trigger time difference between T1 and T2 is Δt12 a trigger time difference between T2 and T3 is Δt23 and relative positions of the terminals may be described by a position matrix

$$\begin{matrix}\begin{matrix}\begin{matrix} \\ T 1\end{matrix} \\ T 2\end{matrix} \\ T 3\end{matrix} \begin{matrix}\begin{matrix}T 1 & T 2 & T 3\end{matrix} \\ [ \begin{matrix}0 & Δ t 12 & Δ t 13 \\ Δ t 21 & 0 & Δ t 23 \\ Δ t 31 & Δ t 32 & 0\end{matrix} ] .\end{matrix}$$

In some embodiments of the present invention, after step 503 of this embodiment of the present invention, the multi-terminal positioning method may further include:

calculating, by the primary terminal according to the trigger time difference and an empirical speed value, a relative distance between the successively triggered terminals as the relative position between the successively triggered terminals.

That is, the relative position may be described by using the trigger time difference, and the relative position may also be described by calculating an appropriate distance between terminals by using the empirical speed value or a calculated sliding speed, and the trigger time difference.

In this embodiment, a primary terminal implements calculation of an arrangement sequence of all terminals and relative positions between the terminals according to a recorded arrangement shape and demarcated gesture, and sensor trigger information, so as to complete positioning of multiple terminals in only one demarcation process, thereby improving efficiency of positioning multiple terminals.

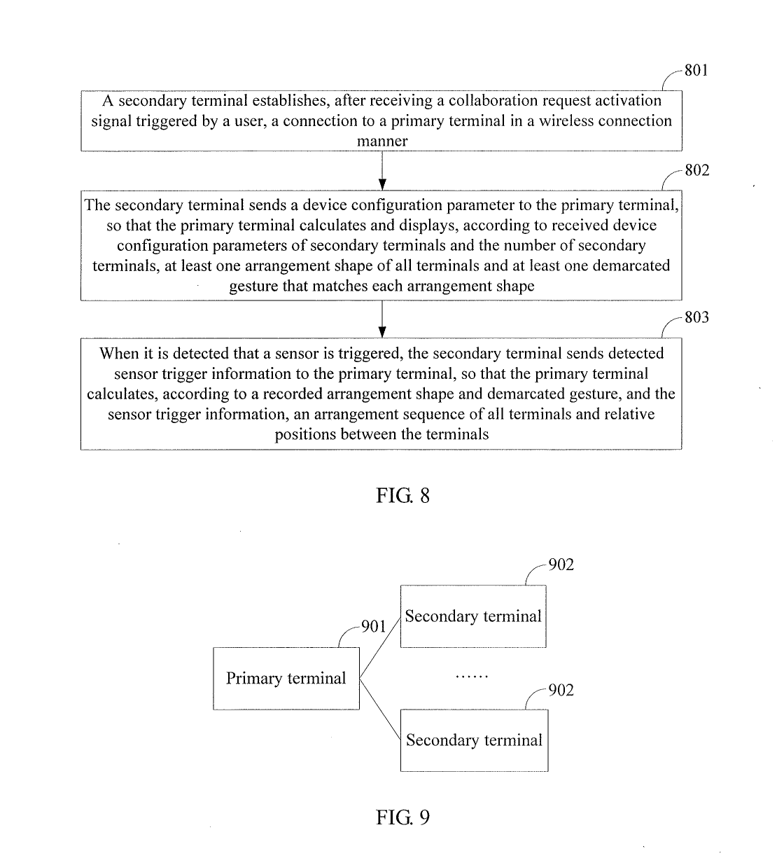

As shown in FIG. 8, Embodiment 4 of the multi-terminal positioning method in the embodiments of the present invention may include the following steps, and a secondary terminal is used as an execution body in the description of this embodiment:

Step 801: The secondary terminal establishes, after receiving a collaboration request activation signal triggered by a user, a connection to a primary terminal in a wireless connection manner.

A collaboration function needs to be activated for all terminals that need to participate in collaboration. For example, the collaboration request activation signal may be sent by starting a dedicated app. After receiving the collaboration request activation signal triggered by the user, the secondary terminal establishes a connection to the primary terminal in a wireless connection manner, where the wireless connection manner may be various manners, including but not limited to Wi-fi, Miracast, 3G, Bluetooth, and so on.

In this embodiment, a terminal among all terminals that meets a preset condition may be determined as the primary terminal, and other terminals are determined as secondary terminals. That is, the primary terminal is a terminal among all terminals that meets a preset condition. As a primary device in interaction, the primary terminal can receive user operation information and information sent by the secondary terminals, and implement multi-terminals positioning. The secondary terminals can send information such as a device configuration parameter or detected sensor trigger information to the primary terminal so that the primary terminal can implement multi-terminals positioning.

Step 802: The secondary terminal sends a device configuration parameter to the primary terminal, so that the primary terminal calculates and displays, according to received device configuration parameters of secondary terminals and the number of secondary terminals, at least one arrangement shape of all terminals and at least one demarcated gesture that matches each arrangement shape.

The secondary terminals may send device configuration parameters, for example, a terminal screen size parameter and a screen resolution, to the primary terminal, so that the primary terminal can calculate, according to the device configuration parameters of the secondary terminals and the number of secondary terminals, a possible arrangement shape of all terminals and multiple demarcated gestures that match each arrangement shape.

Step 803: When it is detected that a sensor is triggered, the secondary terminal sends detected sensor trigger information to the primary terminal, so that the primary terminal calculates, according to the recorded arrangement shape and demarcated gesture, and the sensor trigger information, an arrangement sequence of all terminals and relative positions between the terminals.

Various sensors are disposed in a terminal. A sensor is triggered when the user slides on the terminal by using a demarcated gesture. The sensor may include but is not limited to an infrared sensor, a light sensor, a terminal capacitive screen, an ultrasonic detector, or an image sensor. Therefore, the demarcated gesture used by the user may be an air gesture.

Currently, the sensors integrated in the terminals are basically switching sensors, and some sensors are further capable of detecting several discrete states. Therefore, trigger manners may be classified into slide triggering and press triggering.

The secondary terminal can detect a change of sensor signals and send detected sensor trigger information to the primary terminal. It should be noted that various sensors may be triggered in a gesture demarcation process, and various sensor trigger information is sent to the primary terminal altogether. In some embodiments of the present invention, the sensor trigger information may include but is not limited to trigger time, a trigger manner, and a sensor triggering type. Information about the sensor triggering type may include but is not limited to one or a combination of infrared triggering, light triggering and image triggering. If the trigger manner is press triggering, information about trigger time may be boundary time when the triggering starts or ends.

In this embodiment, when a user triggers sensors of a terminal by using a demarcated gesture, a secondary terminal sends detected sensor trigger information to a primary terminal, so that the primary terminal may directly calculate an arrangement sequence of all terminals and relative positions of the terminals according to the sensor trigger information, a terminal arrangement shape selected by the user, and a corresponding demarcated gesture, so as to complete positioning multiple terminals in only one demarcation process, thereby improving the positioning efficiency. In addition, according to this embodiment of the present invention, the sensor trigger information is obtained by using a gesture to trigger the sensors, which, with a strong anti-interference capability, is not easily subjected to interference from environmental noise.

Corresponding to the embodiments of the foregoing multi-terminal positioning method, as shown in FIG. 9, the present invention further provides an embodiment of a multi-terminal positioning system where the system includes a primary terminal 901 and several secondary terminals 902.

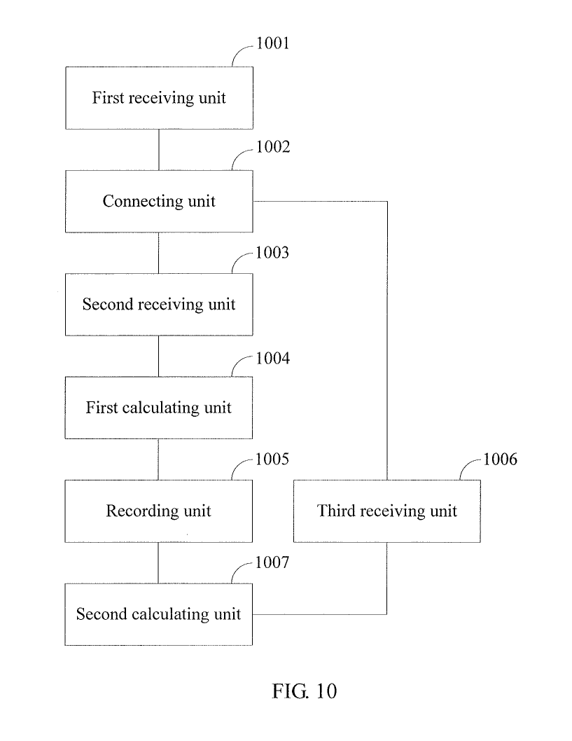

In some embodiments of the present invention, a terminal among all terminals that meets a preset condition may be determined as a primary terminal, and other terminals are determined as secondary terminals. That is, the primary terminal is a terminal among all terminals that meets the preset condition. As shown in FIG. 10, Embodiment 1 of the primary terminal in the embodiments of the present invention may include:

a first receiving unit 1001, configured to receive a collaboration request activation signal triggered by a user;

a connecting unit 1002, configured to establish connections to secondary terminals in a wireless connection manner when the first receiving unit receives the collaboration request activation signal;

a second receiving unit 1003, configured to receive device configuration parameters of the secondary terminals that have established connections to the primary terminal by using the connecting unit;

a first calculating unit 1004, configured to calculate and display, according to the device configuration parameters received by the second receiving unit and the number of secondary terminals, at least one arrangement shape of all terminals and at least one demarcated gesture that matches each arrangement shape;

a recording unit 1005, configured to, after the first calculating unit calculates and displays the at least one arrangement shape of all terminals and the at least one demarcated gesture that matches each arrangement shape, record one arrangement shape selected by the user and one demarcated gesture that matches the arrangement shape; and

a third receiving unit 1006, configured to receive sensor trigger information sent by at least one secondary terminal that has established a connection to the primary terminal by using the connecting unit.

In some embodiments of the present invention, the sensor trigger information may include: trigger time, a trigger manner, and a sensor triggering type.

Information about the sensor triggering type includes one or a combination of infrared triggering, light triggering and image triggering.

A second calculating unit 1007 is configured to calculate, according to the arrangement shape and the demarcated gesture that are recorded by the recording unit and the sensor trigger information received by the third receiving unit, an arrangement sequence of all terminals and relative positions between the terminals.

In some embodiments of the present invention, the primary terminal according to this embodiment of the present invention may further include:

a failure prompting unit, configured to display failure information.

In some embodiments of the present invention, the primary terminal according to this embodiment of the present invention may further include:

a first validity determining unit, configured to determine whether the third receiving unit has received sensor trigger information detected by all the secondary terminals, where if a result of the determining of the first validity determining unit is yes, the second calculating unit calculates, according to the arrangement shape and the demarcated gesture that are recorded by the recording unit and the sensor trigger information received by the third receiving unit, the arrangement sequence of all terminals and the relative positions between the terminals; and if the result of the determining of the first validity determining unit is no, the failure prompting unit displays the failure information, and the third receiving unit receives again the sensor trigger information sent by at least one secondary terminal that has established a connection to the primary terminal by using the connecting unit.

In some embodiments of the present invention, the primary terminal according to this embodiment of the present invention may further include:

a second validity determining unit, configured to determine whether an exception exists in the sensor trigger information received by the third receiving unit, where if a result of the determining of the second validity determining unit is yes, the failure prompting unit displays the failure information, and the third receiving unit receives again the sensor trigger information sent by at least one secondary terminal that has established a connection to the primary terminal by using the connecting unit; and if the result of the determining of the second validity determining unit is no, the second calculating unit calculates, according to the arrangement shape and the demarcated gesture that are recorded by the recording unit and the sensor trigger information received by the third receiving unit, the arrangement sequence of all terminals and the relative positions between the terminals.

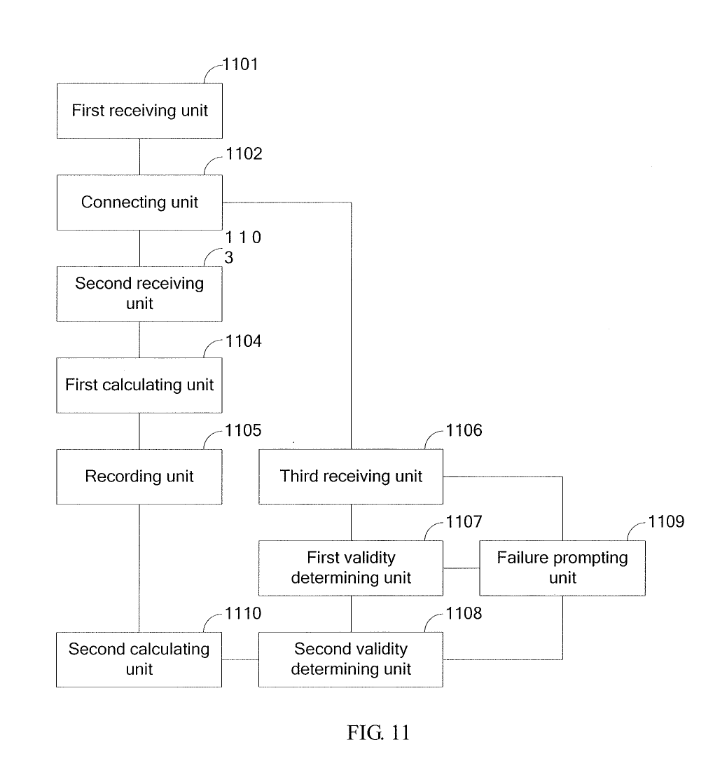

As shown in FIG. 11, Embodiment 2 of the primary terminal in the embodiments of the present invention may include:

a first receiving unit 1101, configured to receive a collaboration request activation signal triggered by a user;

a connecting unit 1102, configured to establish connections to secondary terminals in a wireless connection manner when the first receiving unit receives the collaboration request activation signal;

a second receiving unit 1003, configured to receive device configuration parameters of the secondary terminals that have established connections to the primary terminal by using the connecting unit; a first calculating unit 1104, configured to calculate and display, according to the device configuration parameters received by the second receiving unit and the number of secondary terminals, at least one arrangement shape of all terminals and at least one demarcated gesture that matches each arrangement shape;

a recording unit 1105, configured to, after the first calculating unit calculates and displays the at least one arrangement shape of all terminals and the at least one demarcated gesture that matches each arrangement shape, record one arrangement shape selected by the user and one demarcated gesture that matches the arrangement shape;

a third receiving unit 1106, configured to receive sensor trigger information sent by at least one secondary terminal that has established a connection to the primary terminal by using the connecting unit;

a first validity determining unit 1107, configured to determine whether the third receiving unit has received sensor trigger information detected by all the secondary teiniinals, where if a result of the determining of the first validity determining unit is yes, the second calculating unit calculates, according to the arrangement shape and the demarcation gesture that are recorded by the recording unit and the sensor trigger information received by the third receiving unit, an arrangement sequence of all terminals and relative positions between the terminals; and if the result of the determining of the first validity determining unit is no, a failure prompting unit displays the failure information, and the third receiving unit receives again sensor trigger information sent by at least one secondary terminal that has established a connection to the primary terminal by using the connecting unit; and

a second validity determining unit 1108, configured to determine whether an exception exists in the sensor trigger information received by the third receiving unit, where if a result of the determining of the second validity determining unit is yes, the failure prompting unit displays the failure information, and the third receiving unit receives again sensor trigger information sent by at least one secondary terminal that has established a connection to the primary terminal by using the connecting unit; and if the result of the determining of the second validity determining unit is no, the second calculating unit calculates, according to the arrangement shape and the demarcated gesture that are recorded by the recording unit and the sensor trigger information received by the third receiving unit, the arrangement sequence of all terminals and the relative positions between the terminals, where,

in some embodiments of the present invention, the second validity determining unit according to this embodiment of the present invention may be specifically configured to:

determine, according to the arrangement shape and the demarcated gesture that are recorded by the recording unit, whether any abnormal trigger time exists in the sensor trigger information received by the third receiving unit; or

determine whether any abnormal sensor triggering type exists in the sensor trigger information received by the third receiving unit;

the failure prompting unit 1109, configured to display failure information; and

a second calculating unit 1110, configured to calculate, according to the arrangement shape and the demarcated gesture that are recorded by the recording unit and the sensor trigger information received by the third receiving unit, the arrangement sequence of all terminals and the relative positions between the terminals.

In this embodiment of the present invention, a primary terminal informs a user of a possible arrangement shape of all terminals and a matching demarcated gesture. When the user triggers sensors of the terminals by using the demarcated gesture, the primary terminal may receive sensor trigger information detected by the terminals, directly calculate an arrangement sequence of all terminals and relative positions of the terminals according to the sensor trigger information, a terminal arrangement shape selected by the user, and a corresponding demarcated gesture, so as to complete positioning of multiple terminals in only one demarcation process, thereby improving the positioning efficiency. In addition, according to this embodiment of the present invention, the sensor trigger information is obtained by using a gesture to trigger the sensors, which, with a strong anti-interference capability, is not easily subjected to interference from environmental noise.

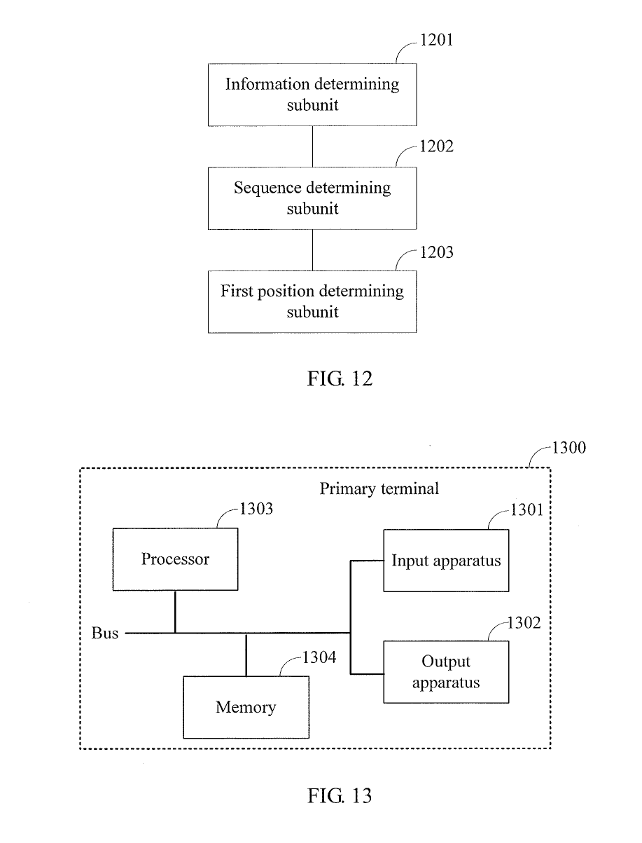

As shown in FIG. 12, in Embodiment 3 of the primary terminal in the embodiments of the present invention, the second calculating unit may include:

an information determining subunit 1201, configured to determine, from at least one piece of sensor trigger information that is sent by each secondary terminal and received by the third receiving unit, sensor trigger information provided by a sensor of a highest priority;

a sequence determining subunit 1202, configured to arrange the terminals in a sequence according to trigger time included in the sensor trigger information that is provided by the sensor of the highest priority in each terminal and determined by the information determining subunit, and determine the arrangement sequence of the terminals according to the arrangement shape and the demarcated gesture that are recorded by the recording unit; and

a first position determining subunit 1203, configured to calculate, according to the trigger time included in the sensor trigger information that is provided by the sensor of the highest priority in each terminal and determined by the information determining subunit, a trigger time difference between successively triggered terminals as a relative position between the successively triggered terminals.

In some embodiments of the present invention, the second calculating unit may further include:

a second position determining subunit, configured to calculate, according to an empirical speed value and the trigger time difference that is obtained by the first position determining subunit by means of calculation, a relative distance between the successively triggered terminals as the relative position between the successively triggered terminals.

In this embodiment, a primary terminal implements calculation of an arrangement sequence of all terminals and relative positions between the terminals according to a recorded arrangement shape and demarcated gesture, and sensor trigger information, and completes positioning multiple terminals in only one demarcation process, thereby improving efficiency of positioning multiple terminals.

The foregoing describes a primary terminal in the embodiments of the present invention from a perspective of a modular functional entity, and the following describes the primary terminal in the embodiments of the present invention from a hardware processing perspective. As shown in FIG. 13, Embodiment 4 of the primary terminal in the embodiments of the present invention may include:

an input apparatus 1301, an output apparatus 1302, a processor 1303, and a memory 1304 (there may be one or more processors 1301 in the primary terminal 1300, and one processor 1301 is used as an example in FIG. 13). In some embodiments of the present invention, the input apparatus 1301, the output apparatus 1302, the processor 1303, and the memory 1304 may be connected by using a bus or in other manners. A connection by using a bus is used as an example in FIG. 13.

By invoking an operation instruction saved in the memory 1304, the processor 1303 is configured to perform the following steps:

establishing, after receiving a collaboration request activation signal triggered by a user, connections to secondary terminals in a wireless connection manner;

calculating and displaying, according to received device configuration parameters of the secondary terminals and the number of secondary terminals, at least one arrangement shape of all terminals and at least one demarcated gesture that matches each arrangement shape, and record one arrangement shape selected by the user and one demarcated gesture that matches the arrangement shape;

receiving sensor trigger information sent by at least one secondary terminal; and

calculating, according to the recorded arrangement shape and demarcated gesture, and the sensor trigger information, an arrangement sequence of all terminals and relative positions between the terminals.

In some embodiments of the present invention, the processor 1303 is further configured to perform the following steps:

determining, from at least one piece of sensor trigger information sent by each secondary terminal, sensor trigger information provided by a sensor of a highest priority;

arranging the terminals in a sequence according to trigger time included in the sensor trigger information provided by the sensor of the highest priority in each terminal, and determine the arrangement sequence of the terminals according to the recorded arrangement shape and demarcated gesture; and

calculating, according to the trigger time included in the sensor trigger information provided by the sensor of the highest priority in each terminal, a trigger time difference between successively triggered terminals as a relative position between the successively triggered terminals.

In some embodiments of the present invention, the processor 1303 is further configured to perform the following step:

calculating, according to the trigger time difference and an empirical speed value, a relative distance between the successively triggered terminals as the relative position between the successively triggered terminals.

In some embodiments of the present invention, the processor 1303 is further configured to perform the following steps:

determining whether sensor trigger information sent by all the secondary terminals is received; if yes, calculating, according to the recorded arrangement shape and demarcated gesture, and the sensor trigger information, the arrangement sequence of all terminals and the relative positions between the terminals; and if no, displaying failure information and receiving again sensor trigger information sent by at least one secondary terminal.

In some embodiments of the present invention, the processor 1303 is further configured to perform the following steps:

determining whether an exception exists in the sensor trigger information; if yes, displaying failure information and receive again sensor trigger information sent by at least one secondary terminal; and if no, calculating, according to the recorded arrangement shape and demarcated gesture, and the sensor trigger information, the arrangement sequence of all terminals and the relative positions between the terminals.

In some embodiments of the present invention, the processor 1303 is further configured to perform the following step:

determining, according to the recorded arrangement shape and demarcated gesture, whether any abnormal trigger time exists in the sensor trigger information; or

determining whether any abnormal sensor triggering type exists in the sensor trigger information.

In this embodiment, when a user is prompted of a possible arrangement shape of all terminals and a matching demarcated gesture, and when the user triggers sensors of the terminals by using the demarcated gesture, a processor 1303 may receive sensor trigger information detected by the terminals, and directly calculate an arrangement sequence of all terminals and relative positions of the terminals according to the sensor trigger information, a terminal arrangement shape selected by the user, and a corresponding demarcated gesture, so as to complete positioning of multiple terminals in only one demarcation process, thereby improving the positioning efficiency. In addition, according to this embodiment of the present invention, the sensor trigger information is obtained by using a gesture to trigger the sensors, which, with a strong anti-interference capability, is not easily subjected to interference from environmental noise.

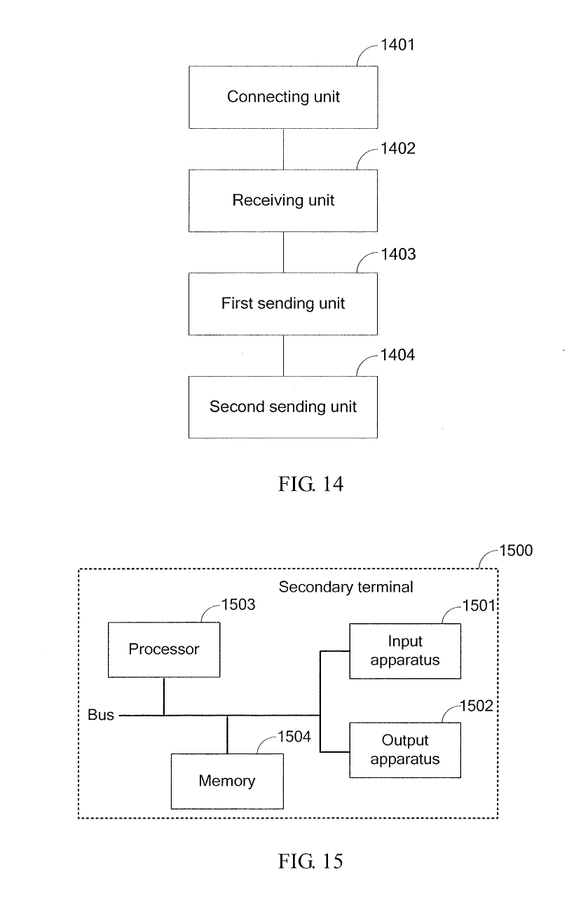

In some embodiments of the present invention, a terminal among all terminals that meets a preset condition may be determined as the primary terminal, and other terminals are determined as the secondary terminals. That is, the primary terminal is a terminal among all terminals that meets the preset condition. As shown in FIG. 14, an embodiment of the a secondary terminal in the embodiments of the present invention may include:

a receiving unit 1401, configured to receive a collaboration request activation signal triggered by a user;

a connecting unit 1402, configured to establish a connection to a primary terminal in a wireless connection manner when the receiving unit receives the collaboration request activation signal;

a first sending unit 1403, configured to send a device configuration parameter to the primary terminal, so that the primary terminal calculates and displays, according to received device configuration parameters of secondary terminals and the number of secondary terminals, at least one arrangement shape of all terminals and at least one demarcated gesture that matches each arrangement shape; and

a second sending unit 1404, configured to, when it is detected that a sensor is triggered, send detected sensor trigger information to the primary terminal, so that the primary terminal calculates, according to the recorded arrangement shape and demarcated gesture, and the sensor trigger information, an arrangement sequence of all terminals and relative positions between the terminals.

In some embodiments of the present invention, the sensor trigger information may include: trigger time, a trigger manner, and a sensor triggering type.

Information about the sensor triggering type includes one or a combination of infrared triggering, light triggering and image triggering.

In this embodiment, when a user triggers sensors of a terminal by using a demarcated gesture, a secondary terminal sends detected sensor trigger information to a primary terminal, so that the primary terminal may directly calculate an arrangement sequence of all terminals and relative positions of the terminals according to the sensor trigger information, a terminal arrangement shape selected by the user, and a corresponding demarcated gesture, so as to complete positioning of multiple terminals in only one demarcation process, thereby improving the positioning efficiency. In addition, according to this embodiment of the present invention, the sensor trigger information is obtained by using a gesture to trigger the sensors, which, with a strong anti-interference capability, is not easily subjected to interference from environmental noise.

The foregoing describes a secondary terminal in embodiments of the present invention from a perspective of a modular functional entity, and the following describes the secondary terminal in the embodiments of the present invention from a hardware processing perspective. As shown in FIG. 15, Embodiment 2 of the secondary terminal in the embodiments of the present invention may include:

an input apparatus 1501, an output apparatus 1502, a processor 1503, and a memory 1504 (there may be one or more processors 1501 in the secondary terminal 1500, and one processor 1501 is used as an example in FIG. 15). In some embodiments of the present invention, the input apparatus 1501, the output apparatus 1502, the processor 1503, and the memory 1504 may be connected by using a bus or in other manners. A connection by using a bus is used as an example in FIG. 15.

By invoking an operation instruction saved in the memory 1504, the processor 1503 is configured to perform the following steps:

establishing, after receiving a collaboration request activation signal triggered by a user, a connection to a primary terminal in a wireless connection manner;

sending a device configuration parameter to the primary terminal, so that the primary terminal calculates and displays, according to received device configuration parameters of secondary terminals and the number of secondary terminals, at least one arrangement shape of all terminals and at least one demarcated gesture that matches each arrangement shape; and

when it is detected that a sensor is triggered, sending detected sensor trigger information to the primary terminal, so that the primary terminal calculates, according to the recorded arrangement shape and demarcated gesture, and the sensor trigger information, an arrangement sequence of all terminals and relative positions between the terminals.

In this embodiment, when a user triggers sensors of a terminal by using a demarcated gesture, a processor 1503 sends detected sensor trigger information to a primary terminal, so that the primary terminal may directly calculate an arrangement sequence of all terminals and relative positions of the terminals according to the sensor trigger information, a terminal arrangement shape selected by the user, and a corresponding demarcated gesture, so as to complete positioning of multiple terminals in only one demarcation process, thereby improving the positioning efficiency. In addition, according to this embodiment of the present invention, the sensor trigger information is obtained by using a gesture to trigger the sensors, which, with a strong anti-interference capability, is not easily subjected to interference from environmental noise.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

It should be further noted that in this specification, relational terms such as first and second are only used to distinguish one entity or operation from another, and do not necessarily require or imply that any actual relationship or sequence exists between these entities or operations. Moreover, the terms “include”, “comprise”, or their any other variant is intended to cover a non-exclusive inclusion, so that a process, a method, an article, or a device that includes a list of elements not only includes those elements but also includes other elements that are not expressly listed, or further includes elements inherent to such a process, method, article, or device. An element preceded by “includes a . . . ” does not, without more constraints, preclude the presence of additional identical elements in the process, method, article, or device that includes the element.

The foregoing embodiments are merely intended to describe the technical solutions of the present invention, but not to limit the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A multi-terminal positioning method, wherein the method comprises:
establishing, by a primary terminal after receiving a collaboration request activation signal triggered by a user, connections to secondary terminals in a wireless connection manner;
calculating and displaying, by the primary terminal according to received device configuration parameters of the secondary terminals and the number of secondary terminals, at least one arrangement shape of all terminals and at least one demarcated gesture that matches each arrangement shape, and recording one arrangement shape selected by the user and one demarcated gesture that matches the arrangement shape;
receiving, by the primary terminal, sensor trigger information sent by at least one secondary terminal; and
calculating, by the primary terminal according to the recorded arrangement shape and demarcated gesture, and the sensor trigger information, an arrangement sequence of all terminals and relative positions between the terminals.

2. The method according to claim 1, wherein the primary terminal is a terminal among all terminals that meets a preset condition.

3. The method according to claim 1, wherein the sensor trigger information comprises:
trigger time, a trigger manner, and a sensor triggering type, wherein
information about the sensor triggering type comprises one or a combination of infrared triggering, light triggering and image triggering.

4. The method according to claim 1, wherein the calculating, by the primary terminal according to the recorded arrangement shape and demarcated gesture, and the sensor trigger information, an arrangement sequence of all terminals and relative positions between the terminals comprises:
determining, by the primary terminal from at least one piece of sensor trigger information sent by each secondary terminal, sensor trigger information provided by a sensor of a highest priority;
arranging, by the primary terminal, the terminals in a sequence according to trigger time comprised in the sensor trigger information provided by the sensor of the highest priority in each terminal, and determining the arrangement sequence of the terminals according to the recorded arrangement shape and demarcated gesture; and
calculating, by the primary terminal according to the trigger time comprised in the sensor trigger information provided by the sensor of the highest priority in each terminal, a trigger time difference between successively triggered terminals as a relative position between the successively triggered terminals.

5. The method according to claim 4, wherein the method further comprises:
calculating, by the primary terminal according to the trigger time difference and an empirical speed value, a relative distance between the successively triggered terminals as the relative position between the successively triggered terminals.

6. The method according to claim 1, wherein, after the receiving, by the primary terminal, sensor trigger information detected by at least one secondary terminal, the method further comprises:
determining, by the primary terminal, whether sensor trigger information sent by all the secondary terminals is received; if yes, calculating, according to the recorded arrangement shape and demarcated gesture, and the sensor trigger information, the arrangement sequence of all terminals and the relative positions between the terminals; and if no, displaying failure information and receiving again sensor trigger information sent by at least one secondary terminal.

7. The method according to claim 6, wherein, after the primary terminal determines that the sensor trigger information sent by all the secondary terminals is received, and before the calculating, according to the recorded arrangement shape and demarcated gesture, and the sensor trigger information, the arrangement sequence of all terminals and the relative positions between the terminals, the method further comprises:
determining, by the primary terminal, whether an exception exists in the sensor trigger information; if yes, displaying failure information and receiving again sensor trigger information sent by at least one secondary terminal; and if no, calculating, according to the recorded arrangement shape and demarcated gesture, and the sensor trigger information, the arrangement sequence of all terminals and the relative positions between the terminals.

8. The method according to claim 7, wherein the determining, by the primary terminal, whether an exception exists in the sensor trigger information comprises:
determining, by the primary terminal according to the recorded arrangement shape and demarcated gesture, whether any abnormal trigger time exists in the sensor trigger information; or
determining, by the primary terminal, whether any abnormal sensor triggering type exists in the sensor trigger information.

9. A multi-terminal positioning method, wherein the method comprises:
establishing, by a secondary terminal after receiving a collaboration request activation signal triggered by a user, a connection to a primary terminal in a wireless connection manner;
sending, by the secondary terminal, a device configuration parameter to the primary terminal, so that the primary terminal calculates and displays, according to received device configuration parameters of secondary terminals and the number of secondary terminals, at least one arrangement shape of all terminals and at least one demarcated gesture that matches each arrangement shape; and
when it is detected that a sensor is triggered, sending, by the secondary terminal, detected sensor trigger information to the primary terminal, so that the primary terminal calculates, according to the recorded arrangement shape and demarcated gesture, and the sensor trigger information, an arrangement sequence of all terminals and relative positions between the terminals.

10. The method according to claim 9, wherein the primary terminal is a terminal among all terminals that meets a preset condition.

11. The method according to claim 9, wherein the sensor trigger information comprises:
trigger time, a trigger manner, and a sensor triggering type; wherein
information about the sensor triggering type comprises one or a combination of infrared triggering, light triggering and image triggering.

12. A primary terminal, wherein the primary terminal comprises:
a first receiving unit, configured to receive a collaboration request activation signal triggered by a user;
a connecting unit, configured to establish connections to secondary terminals in a wireless connection manner when the first receiving unit receives the collaboration request activation signal;
a second receiving unit, configured to receive device configuration parameters of the secondary terminals that have established connections to the primary terminal by using the connecting unit;
a first calculating unit, configured to calculate and display, according to the device configuration parameters received by the second receiving unit and the number of secondary terminals, at least one arrangement shape of all terminals and at least one demarcated gesture that matches each arrangement shape;
a recording unit, configured to, after the first calculating unit calculates and displays the at least one arrangement shape of all terminals and the at least one demarcated gesture that matches each arrangement shape, record one arrangement shape selected by the user and one demarcated gesture that matches the arrangement shape;
a third receiving unit, configured to receive sensor trigger information sent by at least one secondary terminal that has established a connection to the primary terminal by using the connecting unit; and
a second calculating unit, configured to calculate, according to the arrangement shape and the demarcated gesture that are recorded by the recording unit and the sensor trigger information received by the third receiving unit, an arrangement sequence of all terminals and relative positions between the terminals.

13. The primary terminal according to claim 12, wherein the primary terminal is a terminal among all terminals that meets a preset condition.

14. The primary terminal according to claim 12, wherein the sensor trigger information comprises:
trigger time, a trigger manner, and a sensor triggering type; wherein
information about the sensor triggering type comprises one or a combination of infrared triggering, light triggering and image triggering.

15. The primary terminal according to claim 12, wherein the second calculating unit comprises:
an information determining subunit, configured to determine, from at least one piece of sensor trigger information that is sent by each secondary terminal and received by the third receiving unit, sensor trigger information provided by a sensor of a highest priority;
a sequence determining subunit, configured to arrange the terminals in a sequence according to trigger time comprised in the sensor trigger information that is provided by the sensor of the highest priority in each terminal and determined by the information determining subunit, and determine the arrangement sequence of the terminals according to the arrangement shape and the demarcated gesture that are recorded by the recording unit; and
a first position determining subunit, configured to calculate, according to the trigger time comprised in the sensor trigger information that is provided by the sensor of the highest priority in each terminal and determined by the information determining subunit, a trigger time difference between successively triggered terminals as a relative position between the successively triggered terminals.

16. The primary terminal according to claim 15, wherein the second calculating unit further comprises:
a second position determining subunit, configured to calculate, according to an empirical speed value and the trigger time difference that is obtained by the first position determining subunit by means of calculation, a relative distance between the successively triggered terminals as the relative position between the successively triggered terminals.

17. The primary terminal according to claim 14, wherein the primary terminal further comprises:
a failure prompting unit, configured to display failure information; and
a first validity determining unit, configured to determine whether the third receiving unit has received sensor trigger information detected by all the secondary terminals, wherein if a result of the determining of the first validity determining unit is yes, the second calculating unit calculates, according to the arrangement shape and the demarcated gesture that are recorded by the recording unit and the sensor trigger information received by the third receiving unit, the arrangement sequence of all terminals and the relative positions between the terminals; and if the result of the determining of the first validity determining unit is no, the failure prompting unit displays the failure information, and the third receiving unit receives again sensor trigger information sent by at least one secondary terminal that has established a connection to the primary terminal by using the connecting unit.

18. The primary terminal according to claim 14, wherein the primary terminal further comprises:
a failure prompting unit, configured to display failure information; and
a second validity determining unit, configured to determine whether an exception exists in the sensor trigger information received by the third receiving unit, wherein if a result of the determining of the second validity determining unit is yes, the failure prompting unit displays the failure information, and the third receiving unit receives again sensor trigger information sent by at least one secondary terminal that has established a connection to the primary terminal by using the connecting unit; and if the result of the determining of the second validity determining unit is no, the second calculating unit calculates, according to the arrangement shape and the demarcated gesture that are recorded by the recording unit and the sensor trigger information received by the third receiving unit, the arrangement sequence of all terminals and the relative positions between the terminals.

19. The terminal according to claim 18, wherein the second validity determining unit is specifically configured to:
determine, according to the arrangement shape and the demarcated gesture that are recorded by the recording unit, whether any abnormal trigger time exists in the sensor trigger information received by the third receiving unit; or
determine whether any abnormal sensor triggering type exists in the sensor trigger information received by the third receiving unit.

20. A secondary terminal, wherein the secondary terminal comprises:
a receiving unit, configured to receive a collaboration request activation signal triggered by a user;
a connecting unit, configured to establish a connection to a primary terminal in a wireless connection manner when the receiving unit receives the collaboration request activation signal;
a first sending unit, configured to send a device configuration parameter to the primary terminal, so that the primary terminal calculates and displays, according to received device configuration parameters of secondary terminals and the number of secondary terminals, at least one arrangement shape of all terminals and at least one demarcated gesture that matches each arrangement shape; and
a second sending unit, configured to, when it is detected that a sensor is triggered, send detected sensor trigger information to the primary terminal, so that the primary terminal calculates, according to the recorded arrangement shape and demarcated gesture, and the sensor trigger information, an arrangement sequence of all terminals and relative positions between the terminals.

21. The secondary terminal according to claim 20, wherein the primary terminal is a terminal among all terminals that meets a preset condition.

22. The secondary terminal according to claim 20, wherein the sensor trigger information comprises:
trigger time, a trigger manner, and a sensor triggering type; wherein
information about the sensor triggering type comprises one or a combination of infrared triggering, light triggering and image triggering.

23. A multi-terminal positioning system, wherein the system comprises:
a primary terminal and several secondary terminals, wherein
wherein the primary terminal comprises:
a first receiving unit, configured to receive a collaboration request activation signal triggered by a user;
a connecting unit, configured to establish connections to secondary terminals in a wireless connection manner when the first receiving unit receives the collaboration request activation signal;
a second receiving unit, configured to receive device configuration parameters of the secondary terminals that have established connections to the primary terminal by using the connecting unit;
a first calculating unit, configured to calculate and display, according to the device configuration parameters received by the second receiving unit and the number of secondary terminals, at least one arrangement shape of all terminals and at least one demarcated gesture that matches each arrangement shape;
a recording unit, configured to, after the first calculating unit calculates and displays the at least one arrangement shape of all terminals and the at least one demarcated gesture that matches each arrangement shape, record one arrangement shape selected by the user and one demarcated gesture that matches the arrangement shape;
a third receiving unit, configured to receive sensor trigger information sent by at least one secondary terminal that has established a connection to the primary terminal by using the connecting unit; and
a second calculating unit, configured to calculate, according to the arrangement shape and the demarcated gesture that are recorded by the recording unit and the sensor trigger information received by the third receiving unit, an arrangement sequence of all terminals and relative positions between the terminals; and
wherein the secondary terminal comprises:
a receiving unit, configured to receive a collaboration request activation signal triggered by a user;
a connecting unit, configured to establish a connection to a primary terminal in a wireless connection manner when the receiving unit receives the collaboration request activation signal;
a first sending unit, configured to send a device configuration parameter to the primary terminal, so that the primary terminal calculates and displays, according to received device configuration parameters of secondary terminals and the number of secondary terminals, at least one arrangement shape of all terminals and at least one demarcated gesture that matches each arrangement shape; and
a second sending unit, configured to, when it is detected that a sensor is triggered, send detected sensor trigger information to the primary terminal, so that the primary terminal calculates, according to the recorded arrangement shape and demarcated gesture, and the sensor trigger information, an arrangement sequence of all terminals and relative positions between the terminals.
